(19) United States
(12) Patent Application Publication
(10) Pub. No.: US 2020/0371638 A1
(43) Pub. Date: Nov. 26, 2020

(54) TOUCH SENSOR

(71) Applicant: DONGWOO FINE-CHEM CO., LTD., Iksan-si (KR)

(72) Inventors: Seungkook KIM, Seoul (KR); Yumi Ahn, Daegu (KR)

(73) Assignee: DONGWOO FINE-CHEM CO., LTD., Iksan-si (KR)

(21) Appl. No.: 15/931,862

(22) Filed: May 14, 2020

(30) Foreign Application Priority Data
May 21, 2019 (KR) 10-2019-0059417

(51) Int. Cl. G06F 3/044

(52) U.S. Cl. CPC G06F 3/0443

(57) ABSTRACT

The present invention provides a touch sensor comprising: a first transparent oxide electrode layer made of a conductive transparent oxide; a metal electrode layer formed on the first transparent oxide electrode layer and made of a conductive metal; a second transparent oxide electrode layer formed on the metal electrode layer and made of the conductive transparent oxide; and an insulation layer with a refractive index of higher than 1.45 and lower than or equal to 1.55 formed on the second transparent oxide electrode layer, wherein the touch sensor has a transmittance of 85% or more at a wavelength of 360 to 740 nm.

### CROSS REFERENCE TO RELATED APPLICATIONS

This application claims priority based on Korean Patent Application No. 10-2019-0059417, filed May 21, 2019, the entire content of which is incorporated herein by reference in its entirety.

### TECHNICAL FIELD

The present invention relates to a touch sensor. Particularly, the present invention relates to a touch sensor exhibiting an excellent transmittance by mitigating transmittance reduction due to the insulation layer formed on the transparent electrode.

### BACKGROUND ART

In addition to the function of displaying content on the screen, the touch screen panel includes a touch sensor that receives a command by selecting an instruction displayed on the screen with a hand or an object.

Depending on the operation method, there are capacitive touch sensor, photosensitive touch sensor, resistive touch sensor, and so on. Recently, the capacitive touch sensor has been widely used. In the capacitive touch sensor, a change in capacitance between the sensing cell and ground electrode or another sensing cell in the vicinity when a user's hand or object is contacted is converted into an electrical signal and provided to enable the contact position to be identified.

When applied to a touch screen panel, the sensing cell included in the touch sensor needs to have a high transmittance and have necessary electrical characteristics, for example, low resistance. US Patent Publication No. 2010-0141608 discloses that a refractive index matching layer is added on the electrode layer of the touch sensor and the refractive index matching layer can also serve as a passivation layer. US Patent Publication No. 2010-0141608 discloses that a refractive index of the refractive index matching layer is from 1.55 to 1.75.

Meanwhile, in the laminated structure of the lower oxide layer, the metal layer and the upper oxide layer (OMO), although the upper oxide layer has a refractive index of 1.5 to 2.5, the actual refractive index on the top of the upper oxide layer, that is, the refractive index of the transparent electrode, is higher than 1.00 and lower than or equal to 1.45, which is lower than the refractive index of the upper oxide layer, due to the metal layer. As a result, when an insulation layer serving as a protective layer is formed on the upper oxide layer to form a device as a touch sensor, if the refractive index of the insulation layer is over 1.45, the transmittance of the touch sensor may be lowered.

Therefore, there is a need to develop a touch sensor capable of mitigating transmittance reduction due to the insulation layer and ensuring excellent transmittance even if the refractive index of the insulation layer formed on the transparent electrode is over 1.45, which is higher than the refractive index of the transparent electrode.

### DISCLOSURE OF INVENTION

### Technical Problem

It is an object of the present invention to provide a touch sensor capable of mitigating transmittance reduction due to the insulation layer formed on the transparent electrode to ensure excellent transmittance.

### Technical Solution

According to one aspect of the present invention, there is provided a touch sensor comprising: a first transparent oxide electrode layer made of a conductive transparent oxide; a metal electrode layer formed on the first transparent oxide electrode layer and made of a conductive metal; a second transparent oxide electrode layer formed on the metal electrode layer and made of a conductive transparent oxide; and an insulation layer with a refractive index of higher than 1.45 and lower than or equal to 1.55 formed on the second transparent oxide electrode layer, wherein the touch sensor has a transmittance of 85% or more at a wavelength of 360 to 740 nm.

The touch sensor according to an embodiment of the present invention may further comprise a base layer on an opposite side of a surface of the first transparent oxide electrode layer that is in contact with the metal electrode layer.

In an embodiment of the present invention, the first and second transparent oxide electrode layers may have thicknesses of 385 to 450 Å, respectively.

In an embodiment of the present invention, the conductive transparent oxide may be indium zinc oxide (IZO).

In an embodiment of the present invention, the metal electrode layer may have a thickness of 60 to 80 Å.

In an embodiment of the present invention, the metal electrode layer may have a thickness of 60 to 70 Å.

In an embodiment of the present invention, the conductive metal may be silver-palladium-copper alloy (APC).

In an embodiment of the present invention, the insulation layer may have a refractive index of 1.5 to 1.55.

The touch sensor according to an embodiment of the present invention may have a transmittance of 86% or more at a wavelength of 360 to 740 nm.

### Advantageous Effects

According to the touch sensor of the present invention, even if the refractive index of the insulation layer formed on the transparent electrode is higher than 1.45 and lower than or equal to 1.55, which is higher than the refractive index of the transparent electrode, transmittance reduction due to the insulation layer is mitigated by controlling the thicknesses of the first and second transparent oxide electrode layers and the thickness of the metal electrode layer, thereby ensuring transmittance of the touch sensor to be at least 85% at a wavelength of 360 to 740 nm.

### DESCRIPTION OF DRAWINGS

FIG. 1 is a sectional view of a touch sensor according embodiment of the present invention.

FIG. 2 is a graph showing transmittance at a wavelength of 360 to 740 nm of the touch sensor according to the thicknesses of the first and second transparent oxide electrode layers and the thickness of the metal electrode layer.

### BEST MODE

Hereinafter, the present invention will be described in more detail with reference to the accompanying drawings.

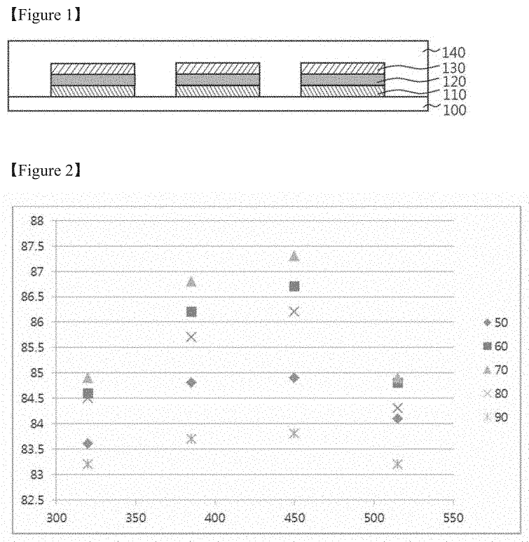

FIG. 1 is a sectional view of a touch sensor according to an embodiment of the present invention.

The touch sensor can be generally divided into a sensing area and a driving area. The sensing area may include a sensing cell part, and the driving area may include a wiring part, a pad electrode part, an FPCB, and so on.

The sensing area comprises a plurality of sensing cells. The sensing cells may be arranged on a transparent substrate in the horizontal (X-axis) and vertical (Y-axis) directions and connected by conductive bridges or the like.

When the sensing cell is located on the front of the touch screen panel, the sensing cell may be formed of a transparent conductive oxide to ensure visibility, and a conductive metal may be included as a part of the sensing cell within a tolerance of ensuring visibility.

Referring to FIG. 1, the touch sensor according to an embodiment of the present invention uses a conductive metal as a part of the transparent electrode, and the transparent electrode is composed of a first transparent oxide electrode layer 110, a metal electrode layer 120 and a second transparent oxide electrode layer 130. An insulation layer 140 is stacked on the transparent electrode to protect the transparent electrode.

That is, the touch sensor comprises the first transparent oxide electrode layer 110; the metal electrode layer 120 formed on the first transparent oxide electrode layer; the second transparent oxide electrode layer 130 formed on the metal electrode layer; and the insulation layer 140 formed on the second transparent oxide electrode layer.

The touch sensor according to an embodiment of the present invention may further include a base layer 100 on an opposite side of a surface of the first transparent oxide electrode layer that is in contact with the metal electrode layer.

In an embodiment of the present invention, the base layer 100 may serve as a support layer of the transparent electrode.

The base layer 100 may be formed of a film-shaped member.

The base layer 100 may be made of glass or polymer material, for example, at least one selected from the group consisting of polyacrylate, polymethacrylate (e.g., PMMA), polyimide, polyamide, polyamic acid, poly vinyl alcohol, polyolefin (e.g., PE, PP), polystyrene, polynorbornene, polymaleimide, polyazobenzene, polyester (e.g., PET, PBT), polyarylate, polyphthalimidine, polyphenylenephthalamide, polyvinylcinnamate, polycinnamate, coumarin polymer, chalcone polymer, aromatic acetylene polymer, phenylmaleimide copolymer, cyclo-olefin polymer (COP), cellulose triacetate (TAC), copolymer thereof, and blend thereof.

In an embodiment of the present invention, the first transparent oxide electrode layer 110 is formed on the base layer 100.

The first transparent oxide electrode layer 110 may have a refractive index of 1.5 to 2.5. If the refractive index is under 1.5, the reflection color may be poor, and if the refractive index exceeds 2.5, visibility may be deteriorated due to a decrease in transmittance of the touch sensor.

The first transparent oxide electrode layer 110 has a thickness of 385 to 450 Å, preferably 400 to 450 Å. If the thickness of the first transparent oxide electrode layer 110 is under 385 Å or over 450 Å, the transmittance at a wavelength of 360 to 740 nm of the touch sensor falls below 85% making it difficult to transmit light in the display area located under the touch sensor.

The first transparent oxide electrode layer 110 is made of conductive transparent oxide.

The conductive transparent oxide may be indium zinc oxide (IZO), indium tin oxide (ITO), aluminum zinc oxide (AZO), zinc oxide (ZnOx), titanium oxide (TiO₂), aluminum oxide (Al₂O₃), etc., and these may be used alone or in combination of two or more, in particular, it is preferable to use indium zinc oxide (IZO) as the conductive transparent oxide in terms of processability such as batch etching with the metal electrode layer.

The first transparent oxide electrode layer 110 can have relatively strong chemical resistance compared to the metal electrode layer 120 and the second transparent oxide electrode layer 130.

The first transparent oxide electrode layer 110 may be formed in a mesh pattern. The mesh pattern may include an internal structure in the form of a net or honeycomb. The mesh pattern may be a right-angled square mesh structure, a rhombus mesh structure, a hexagonal mesh structure, or a concave polygonal mesh structure.

In FIG. 1, the first transparent oxide electrode layer 110 is illustrated in a patterned form, but may also be formed as a non-patterned planar layer. In this case, the first transparent oxide electrode layer 110 may be formed of a non-conductor, and may serve as a lower insulation layer of the metal electrode layer 120.

In an embodiment of the present invention, the metal electrode layer 120 is formed on the first transparent oxide electrode layer 110.

The metal electrode layer 120 may have a refractive index of higher than 0 and less than or equal to 1, preferably 0.3 to 0.5. In this refractive index range, the metal electrode layer 120 can maintain optical properties of the transparent electrode such as transmittance, reflection color, and so forth to ensure visibility.

The metal electrode layer 120 has a thickness of 60 to 80 Å, preferably 60 to 70 Å. When the thickness of the metal electrode layer 120 is less than 60 Å or more than 80 Å, the transmittance of the touch sensor falls below 85% making it difficult to transmit light in the display area located under the touch sensor.

The metal electrode layer 120 is made of a conductive metal.

As the conductive metal, a metal such as silver (Ag), copper (Cu), gold (Au), aluminum (Al), platinum (Pt), palladium (Pd), chromium (Cr), tungsten (W), titanium (Ti), tantalum (Ta), iron (Fe), cobalt (Co), nickel (Ni), zinc (Zn), telenium (Te), vanadium (V) , niobium (Nb), molybdenum (Mo), an alloy of these metals (for example, silver-palladium-copper alloy (APC)), a nanowire of metal or alloy, etc. may be used. In particular, it is preferable to use silver-palladium-copper alloy (APC) in terms of conductivity and corrosion resistance.

The metal electrode layer 120 may be formed in a mesh pattern. The mesh pattern may include an internal structure in the form of a net or honeycomb. The mesh pattern may be a right-angled square mesh structure, a rhombus mesh structure, a hexagonal mesh structure, or a concave polygonal mesh structure.

In an embodiment of the present invention, the second transparent oxide electrode layer 130 is formed on the metal electrode layer 120.

The second transparent oxide electrode layer 130 may have a refractive index of 1.5 to 2.5. If the refractive index is under 1.5, the reflection color may be poor, and if the refractive index exceeds 2.5, visibility may be deteriorated due to a decrease in transmittance of the touch sensor.

The second transparent oxide electrode layer 130 has a thickness of 385 to 450 Å, preferably 400 to 450 Å. If the thickness of the second transparent oxide electrode layer 130 is under 385 Å or over 450 Å, the transmittance at a wavelength of 360 to 740 nm of the touch sensor falls below 85% making it difficult to transmit light in the display area located under the touch sensor.

The second transparent oxide electrode layer 130 is made of conductive transparent oxide.

The conductive transparent oxide may be indium zinc oxide (IZO), indium tin oxide (ITO), aluminum zinc oxide (AZO), zinc oxide (ZnOx), titanium oxide (TiO₂), aluminum oxide (Al₂O₃), indium zinc tin oxide (IZTO), indium oxide (InOx), tin oxide (SnOx), cadmium tin oxide (CTO), gallium-doped zinc oxide (GZO), zinc tin oxide (ZTO), indium gallium oxide (IGO), etc., and these may be used alone or in combination of two or more. In particular, it is preferable to use indium zinc oxide (IZO) as the conductive transparent oxide in terms of processability such as batch etching with the metal electrode layer.

The second transparent oxide electrode layer 130 may be formed in a mesh pattern. The mesh pattern may include an internal structure in the form of a net or honeycomb. The mesh pattern may be a right-angled square mesh structure, a rhombus mesh structure, a hexagonal mesh structure, or a concave polygonal mesh structure,

The method of forming the first transparent oxide electrode layer 110, the metal electrode layer 120 and the second transparent oxide electrode layer 130 of the present invention is not particularly limited, and they may be formed by various thin film deposition techniques such as physical vapor deposition (PVD) and chemical vapor deposition (CVD). For example, they may be formed by reactive sputtering, which is an example of the physical vapor deposition method.

In an embodiment of the present invention, the method for forming the mesh pattern is not particularly limited, and it may be formed, for example, by photolithography.

The method of forming the mesh pattern including the first transparent oxide electrode layer 110, the metal electrode layer 120 and the second transparent oxide electrode layer 130 of the present invention is not particularly limited. For example, the first transparent oxide electrode layer 110, the metal electrode layer 120 and the second transparent oxide electrode layer 130 may be sequentially stacked and etched simultaneously by photolithography, or each layer may be etched individually.

The refractive index of the transparent electrode composed of the first transparent oxide electrode layer 110, the metal electrode layer 120 and the second transparent oxide electrode layer 130 may be higher than 1.00 and lower than or equal to 1.45. In the touch sensor according to the present invention, even though the refractive index of the insulation layer formed on the transparent electrode is higher than 1.45 and lower than or equal to 1.55, which is higher than that of the transparent electrode, transmittance reduction due to the insulation layer is mitigated by controlling the thicknesses of the first and second transparent oxide electrode layers to 385 to 450 Å and the thickness of the metal electrode layer to 60 to 80 Å. In result, the transmittance of the touch sensor at a wavelength of 360 to 740 nm may be ensured to be 85% or more.

In an embodiment of the present invention, the insulation layer 140 serves to prevent corrosion of the transparent electrode and protect the surface of the transparent electrode.

The insulation layer 140 is formed on the second transparent oxide electrode layer 130 to cover the transparent electrode, and is formed to have a flat surface opposite to the surface contacting the transparent electrode.

The insulation layer 140 may be configured to have a refractive index of higher than 1.45 and less than or equal to 1.55, preferably 1.5 to 1.55, which is higher than the refractive index of the transparent electrode as described above.

The insulation layer 140 may be made of an inorganic insulation material or an organic insulation material. It is preferable in terms of flexibility to use the organic insulation material.

Examples of the inorganic insulation material include inorganic oxides such as silicon oxide. As the organic insulation material, an organic resin composition including a thermosetting or photo-curable material such as an epoxy compound, an acrylic compound, and a melanin compound may be used.

The insulation layer 140 may have a thickness of 2 to 4 μm from the upper surface of the second transparent oxide electrode layer 130.

The touch sensor according to an embodiment of the present invention has a transmittance of 85% or more at a wavelength of 360 to 740 nm, which is sufficient to transmit light in the display area disposed under the touch sensor, ensuring visibility, luminance, and the like of the display.

The touch sensor according to an embodiment of the present invention controls the thicknesses of the first and second transparent oxide electrode layers to 385 to 450 Å and the thickness of the metal electrode layer to 60 to 70 Å to ensure the transmittance of the touch sensor at a wavelength of 360 to 740 nm to be 85% or more. preferably 86% or more.

Hereinafter, the present invention will be described in more detail with reference to Examples, Comparative Examples and Experimental Examples. It is apparent to those skilled in the art that these Examples, Comparative Examples and Experimental Examples are only for describing the present invention and the scope of the present invention is not limited thereto.

### Examples 1 to 6 and Comparative Examples 1 to 14: Preparation of a Touch Sensor

A touch sensor was prepared in the same structure as in the embodiment of FIG. 1.

A glass material having a thickness of 0.7 mm was used as the base layer.

Indium zinc oxide (IZO) was used for the first transparent oxide electrode layer and the second transparent oxide electrode layer, and silver-palladium-copper (APC) alloy was used for the metal electrode layer.

The first transparent oxide electrode layer, the metal electrode layer, and the second transparent oxide electrode layer were sequentially stacked on the base layer with thicknesses shown in Table 1 by sputtering, and then etched by photolithography to prepare the transparent electrode.

An insulation layer was laminated on the second transparent oxide electrode layer to cover the transparent electrode with a thickness of 2 μm from the top surface of the second transparent oxide electrode layer. As the insulation layer, an acrylic resin having a refractive index of 1.5 was used.

### Experimental Example 1: Transmittance of the Touch Sensor

The transmittance at a wavelength of 360 to 740 nm of the touch sensor prepared in the above Examples and Comparative Examples was measured, and the results are shown in Table 1 and FIG. 2 below.

The transmittance was measured using a Minolta 3600D instrument.

In FIG. 2, the horizontal (X-direction) axis represents the thickness of the first and second transparent oxide electrode layers, and the vertical (Y-direction) axis represents the transmittance at a wavelength of 360 to 740 nm of the touch sensor.

TABLE 1

| | APC thickness | IZO thickness | transmittance |
|---|---|---|---|
| Comparative Example 1 | 50 | 320 | 83.6 |
| Comparative Example 2 | 50 | 385 | 84.8 |
| Comparative Example 3 | 50 | 450 | 84.9 |
| Comparative Example 4 | 50 | 515 | 84.1 |
| Comparative Examples 5 | 60 | 320 | 84.6 |
| Example 1 | 60 | 385 | 86.2 |
| Example 2 | 60 | 450 | 86.7 |
| Comparative Example 6 | 60 | 515 | 84.8 |
| Comparative Example 7 | 70 | 320 | 84.9 |
| Example 3 | 70 | 385 | 86.8 |
| Example 4 | 70 | 450 | 87.3 |
| Comparative Example 8 | 70 | 515 | 84.9 |
| Comparative Example 9 | 80 | 320 | 84.5 |
| Example 5 | 80 | 385 | 85.7 |
| Example 6 | 80 | 450 | 85.9 |
| Comparative Example 10 | 80 | 515 | 84.3 |
| Comparative Example 11 | 90 | 320 | 83.2 |
| Comparative Example 12 | 90 | 385 | 83.7 |
| Comparative Example 13 | 90 | 450 | 83.8 |
| Comparative Example 14 | 90 | 515 | 83.2 |

Through Table 1 and FIG. 2, it was confirmed that the touch sensors of Examples 1 to 6 according to the present invention had excellent transmittance of 85% or more, which was sufficient to transmit light in the display area located under the touch sensor, even when the insulation layer having a refractive index of 1.5 was stacked on the second transparent oxide electrode layer. However, when the insulation layer having a refractive index of 1.5 was stacked on the second transparent oxide electrode layer, the touch sensors of Comparative Examples 1 to 14 in which the thicknesses of the first and second transparent oxide electrode layers deviate from 385 to 450 Å or the thickness of the metal electrode layer deviates from 60 to 80 Å had a transmittance of less than 85%, making it difficult to transmit light in the display area located under the touch sensor. In addition, when the thickness of the metal electrode layer was 60 to 70 Å, the transmittance of the touch sensor was excellent as 86% or more.

Although particular embodiments of the present invention have been shown and described, it will be understood by those skilled in the art that it is not intended to limit the present invention to the preferred embodiments, and it will he obvious to those skilled in the art that various changes and modifications may be made without departing from the spirit and scope of the invention.

The scope of the present invention, therefore, is to be defined by the appended claims and equivalents thereof.

### DESCRIPTION OF REFERENCE NUMERALS

| | |
|---|---|
| 100: base layer | 110: first transparent oxide electrode layer |
| 120: metal electrode layer | 130: second transparent oxide electrode layer |
| 140: insulation layer | |

1. A touch sensor comprising:
a first transparent oxide electrode layer made of a conductive transparent oxide;
a metal electrode layer formed on the first transparent oxide electrode layer and made of a conductive metal;
a second transparent oxide electrode layer formed on the metal electrode layer and made of a conductive transparent oxide; and
an insulation layer with a refractive index of higher than 1.45 and lower than or equal to 1.55 formed on the second transparent oxide electrode layer, wherein the touch sensor has a transmittance of 85% or more at a wavelength of 360 to 740 nm.

2. The touch sensor according to claim 1. further comprising a base layer on an opposite side of a surface of the first transparent oxide electrode layer that is in contact with the metal electrode layer.

3. The touch sensor according to claim 1, wherein the first and second transparent oxide electrode layers have thicknesses of 385 to 450 Å, respectively.

4. The touch sensor according to claim 1, wherein the conductive transparent oxide is indium zinc oxide (IZO).

5. The touch sensor according to claim 1, wherein the metal electrode layer has a thickness of 60 to 80 Å.

6. The touch sensor according to claim 1, wherein the metal electrode layer has a thickness of 60 to 70 Å.

7. The touch sensor according to claim 1, wherein the conductive metal is silver-palladium-copper alloy (APC).

8. The touch sensor according to claim 1, wherein the insulation layer has a refractive index of 1.5 to 1.55.

9. The touch sensor according to claim 1, wherein the touch sensor has a transmittance of 86% or more at a wavelength of 360 to 740 nm.
